(19) United States
(12) Patent Application Publication
(10) Pub. No.: US 2004/0001294 A1
(43) Pub. Date: Jan. 1, 2004

(54) Portable water heating system

(76) Inventor: Ralph D'Agosta, New Preston, CT (US)

Correspondence Address: ST. ONGE STEWARD JOHNSTON & REENS, LLC, 986 BEDFORD STREET, STAMFORD, CT, 06905-5619, US

(21) Appl. No.: 10/606,414

(22) Filed: Jun. 26, 2003

Related U.S. Application Data
(63) Continuation-in-part of application No. 10/364,680, filed on Feb. 11, 2003.
(60) Provisional application No. 60/356,242, filed on Feb. 12, 2002.

(51) Int. Cl. H02H 5/04

(52) U.S. Cl. 361/106

(57) ABSTRACT

Methods and systems are provided for a portable water heating system. The system comprises a housing with an inside and an outside, a water inlet disposed on the outside of the housing, a first hose nipple attached to the water inlet, the first hose nipple adapted to connect a water source to the system, a heating element adapted to heat water inside the housing, a lining disposed inside of the housing, the lining adapted to protect the inside of the housing from water corrosion, a water outlet disposed on the outside of the housing and a second hose nipple attached to the water outlet, the second hose nipple adapted to connect a fluid conduit for heated water distribution. The method comprises providing a portable water heating system with a heating element, controlling the heating element operation with an adjustable thermostatic control, providing a ground fault detecting device between the adjustable thermostatic control and the external electrical supply and shutting off the system with a high temperature shutoff element forming a part of the adjustable thermostatic control, when a predetermined threshold has been exceeded.

### REFERENCE TO RELATED APPLICATIONS

This application is a continuation-in-part of currently pending U.S. patent application Ser. No. 10/364,680 filed Feb. 11, 2003 which claims the benefit of, under 35 U.S.C. 119(e), U.S. Provisional Patent Application No. 60/356,242 filed Feb. 12, 2002.

### FIELD OF THE INVENTION

The present invention relates to systems and methods of providing an economical, simple, and effective portable water heating source.

### BACKGROUND OF THE INVENTION

Water is generally taken for granted in industrialized countries. In fact, water is such a common component of everyday life, that few people stop to think about its availability. It is simply expected to be at the ready. It is the rare exception when heated and cold running water are not available in almost any inhabited building.

Water is also expected to be available in uninhabited areas. Faucets are plumbed on the outside of most homes, in barnyards, in agricultural settings, on the side of garages. Yet, one of the times that water is not on hand is when heated water is desired outside. The availability of heated water out of doors is useful in many applications. In general heated water as opposed to cold water increases the cleaning action of detergents, increases the miscibility of additives, encourages development of vegetation, and is more comfortable when used on animals or people. For example, in animal husbandry, heated water may be effectively used in bathing animals at a comfortable temperature, increasing the effectiveness in cleaning stalls, increasing the effectiveness of water based disinfectants, and similar applications. Heated water also is applicable when mixed in veterinary emergencies such as irrigating cuts and wounds.

Heated water may also be effectively used in washing the exteriors of structures, especially in combination with pressure washing, in washing automobiles, in watering vegetation indigenous to warmer climates encouraging their development when grown in colder climates.

Heated water is also useful for camping and outdoor sports. Campers are likely to feel that a taking a hot shower, or washing dishes, utensils, and other applications are much better with heated water than with cold water. Military, paramilitary, and emergency applications may require heated water for the treatment of injured, cleaning of equipment, and numerous other reasons.

The need for heated water out of doors has been met in the past by carting heated water outside or using inefficient air polluting diesel or gas powered portable heated water heaters. Such heaters are bulky and require a tank of significant capacity to operate efficiently. In some applications, such tanks are entirely inappropriate because they are too noisy and/or polluting. In other situations, such tanks simply are too large and costly when only a small amount of heated water is needed. Another problem with existing portable heated water systems is that they have a short life or pose maintenance problems due to corrosion problems.

Further such large tanks often are not convenient because of size, incompatible dispensing connections, and power source. Most convenient would be a heated water dispensing unit that is portable, has dispensing connections that are compatible with readily available conduits, and is powered from a common power source. Around the home, a common power source is a electrical outlet, and a common connection type is a hose. However, in some situations other power or connections may be desired.

Therefore, what is desired is a portable device that provides heated water out-of-doors, stores the heated water for later use, receives cold water for heating and dispenses heated water through standard hose connections, and is compatible with the environment. Consequently, what is needed is a portable heated water system that can deliver heated water safely, conveniently, with low maintenance and in a unit that is highly portable.

### SUMMARY OF THE INVENTION

Accordingly, it is an object of the present invention to provide a system to deliver heated water from a portable heated water system with increased safety.

Another object of the invention is to provide a novel method of providing a low maintenance portable heated water system.

A further object of the invention is to provide a portable heated water system that is more convenient to use than existing portable heated water systems.

Still another object of the invention is to provide a portable heated water system that is more portable than existing portable heated water system due to a reduction in weight and size.

Still yet another object of the invention is to provide a portable heated water system that couples with connections readily available to the average homeowner.

Another object of the invention is to provide a portable heated water system that can be powered by remote sources of power such as a portable generator and/or a vehicle's electrical system coupled with an inverter.

These and other objects of the present invention are achieved by provision of a portable water heating system, the system comprising a housing with an inside and an outside, a water inlet disposed on the outside of the housing, a first hose nipple attached to the water inlet, the first hose nipple adapted to connect a water source to the system, a heating element adapted to heat water inside the housing, a lining disposed inside of the housing, the lining adapted to protect the inside of the housing from water corrosion, a water outlet disposed on the outside of the housing and a second hose nipple attached to the water outlet, the second hose nipple adapted to connect a fluid conduit for heated water distribution.

Preferably, the system further comprising an adjustable thermostatic control controlling the output of the heating element, a first ground fault protection device disposed between an external electrical supply and the adjustable thermostatic control and a high temperature shutoff element located in the adjustable thermostatic control, the high temperature shutoff element protecting the system by shutting the system down when a predetermined threshold temperature has been exceeded, a set of wheels mounted on the outside of the housing, a handle attached to the outside of the housing, a mounting element interface located on the outside of the housing, the mounting element interface securing the system to a mounting element when not in use, an insulated barrier surrounding the outside of the housing, a second ground fault protection device disposed between the external electrical supply and the heating element, and wherein no coiled water conducting tube is provided so as to remove an element prone to failure due to clogging from the system, a relief value disposed on the outside of the housing, wherein the housing comprises a double walled housing and an anode disposed inside the housing, the anode protecting parts located on the inside of the housing from corrosive effects of water and wherein an outer wall of the housing is made of a material different than an inner wall of the housing, the handle is selected from the group consisting of a fixed handle, a folding handle, a retractable handle, a molded handle and combinations of these, the housing material is selected from the group of materials comprising plastic, metal, metal-alloys, rubber, fiberglass, epoxy, synthetic rubber compounds, latex compounds, polyurethane, fiber resin composite materials and combinations of these.

Other objects of the present invention are achieved by provision of a method of providing increased safety when using a portable water heating system, the method comprising providing a portable water heating system with a heating element, controlling the heating element operation with an adjustable thermostatic control, providing a ground fault detecting device between the adjustable thermostatic control and the external electrical supply and shutting off the system with a high temperature shutoff element forming a part of the adjustable thermostatic control, when a predetermined threshold has been exceeded.

Other objects, features and advantages according to the present invention will become apparent from the following detailed description of certain advantageous embodiments when read in conjunction with the accompanying drawings in which the same components are identified by the same reference numerals.

### BRIEF DESCRIPTION OF THE DRAWINGS

FIG. 1 shows a side elevation view of the present invention;

FIG. 2 is a schematic view an exemplary setup of the connections of the heating element according to the invention of FIG. 1;

FIG. 3 is a schematic view of an exemplary setup of the anode and heating element according to the invention of FIG. 1;

FIG. 4 is a schematic view of an exemplary setup of the heating element according to the system of FIG. 1;

FIG. 5 is a schematic view of an exemplary setup of the ground fault detection device according to the system of FIG. 1;

FIG. 6 is a schematic view of an exemplary setup of the adjustable thermostatic control according to the system of FIG. 1;

FIG. 7A is a schematic view of an exemplary setup of the handle, mounting element interface and wheel elements according to the system of FIG. 1;

FIG. 7B is a schematic view of an exemplary setup of the handle and roller elements according to the system of FIG. 1;

FIG. 7C is a schematic view of an exemplary setup of the handle and wheel elements according to the system of FIG. 1;

FIG. 8A shows a side elevation views of the present invention according to the system of FIG. 1;

FIG. 8B shows a side elevation views of the present invention according to the system of FIG. 1; and

FIG. 8C shows a side elevation views of the present invention according to the system of FIG. 1.

### DETAILED DESCRIPTION OF THE DRAWINGS

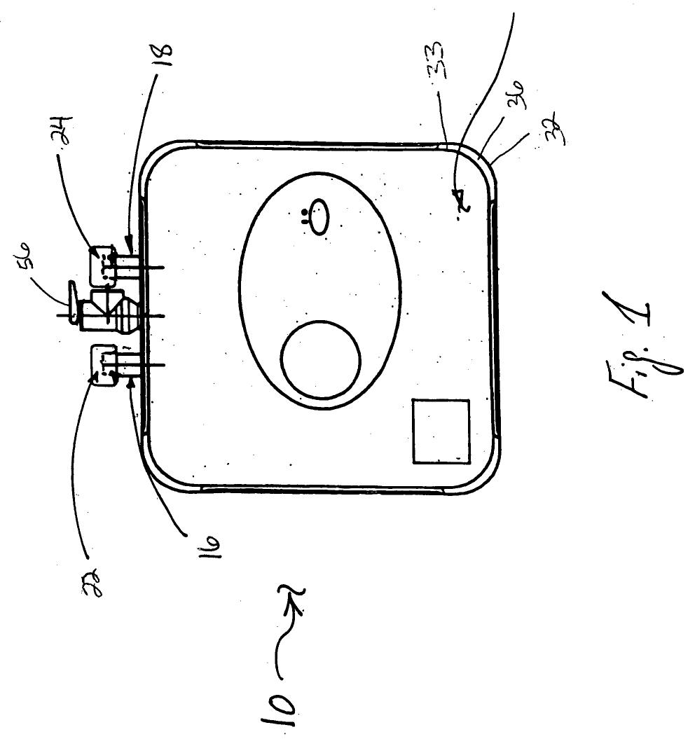

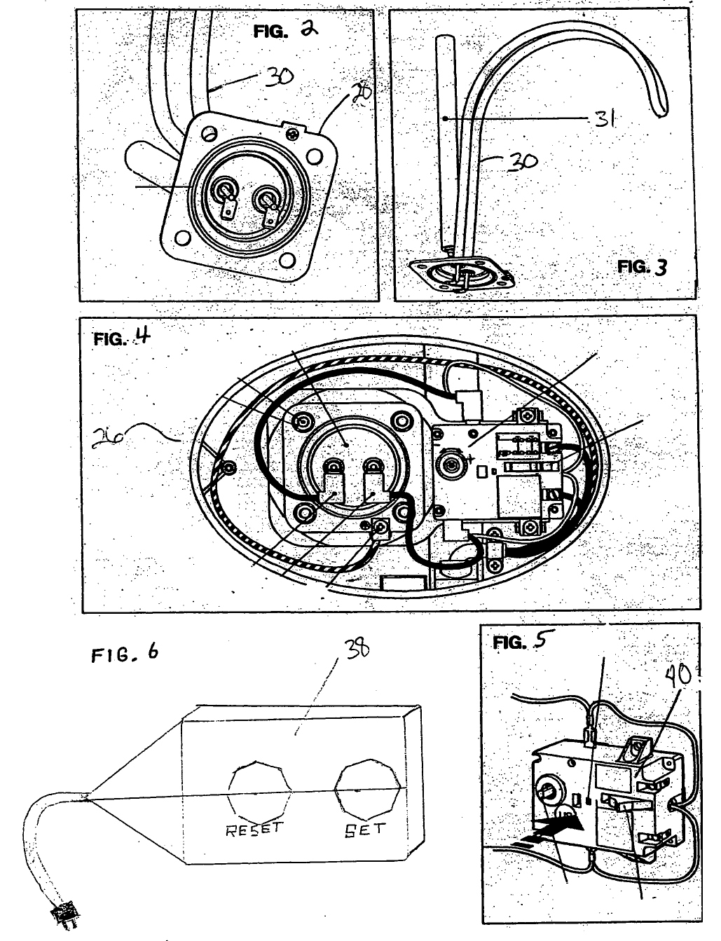

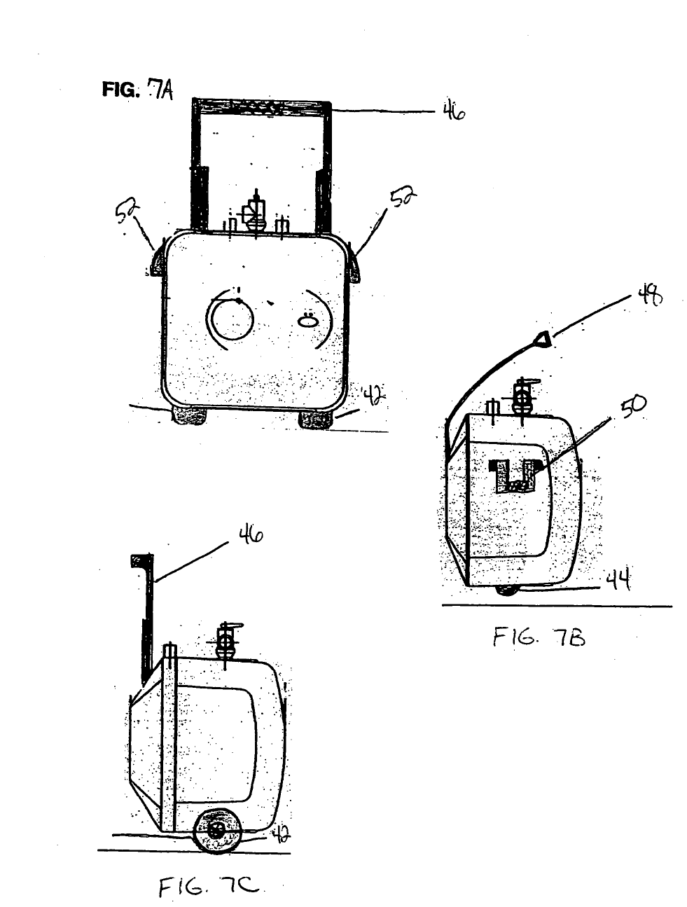

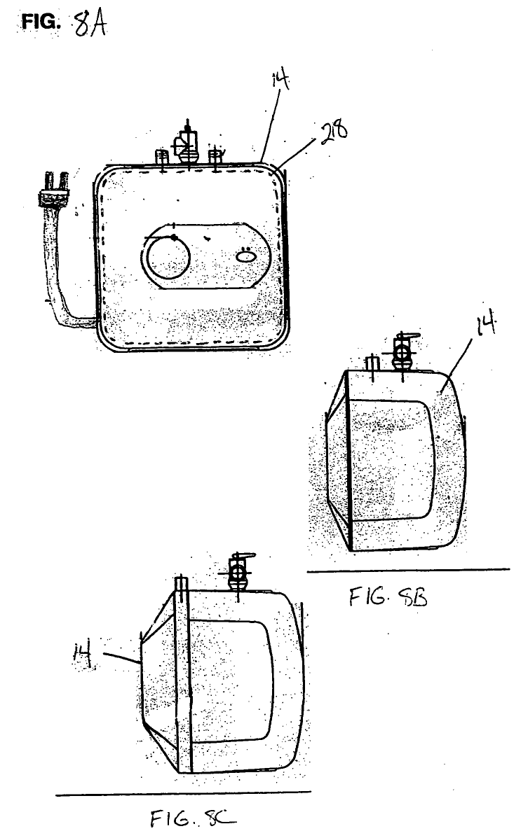

Referring now to the drawings, FIG. 1 shows a side view of portable water heating system 10 in accordance with one embodiment of the invention. A housing 14 is provided, which has an inside and outside. Housing 14 can be constructed from various materials such as plastic, metal, metal-alloys, rubber, fiberglass, epoxy, synthetic rubber compounds, latex compounds, polyurethane, fiber resin composite materials and combinations of these materials, however, other materials may also be used. Housing 14 can be a single walled construction unit (FIG. 8B) or in an alternative embodiment, a double walled constructed unit as shown in FIG. 1, having a first wall 33 and a second wall 32.

In one alternative embodiment, there is disposed an insulating layer 36 (FIG. 1) between first wall 33 and second wall 32. In another alternative embodiment, the insulating barrier can be disposed on the outside of housing 14. And in yet another embodiment of the invention, second wall 32 is made of a material different than the material of first wall 33.

Housing 14 has water inlet 16 and water outlet 18 is sealingly mounted on an outer surface of housing 14 but both water inlet 16 and water outlet 18 provide access to the inside of housing 14. The seal between housing 14 and both water inlet 16 and water outlet 18 is preferably made by the use of Teflon tape, however, any other pipe fitting sealing material or the employment of a mechanical joint or metal joinery may be used.

Disposed on the end of water inlet 16 is first hose nipple 22, which is operably connected to water inlet 16. The connection between the end of water inlet 16 and first hose nipple 22 can be a female/male thread combination, a mechanical joint, an adhesive joint or metal joinery such as a solder joint. Preferably, the first hose nipple 30 is a ¾″ FH×½″ FIP first hose nipple. However, any other suitable and/or desired nipple may also be used.

Disposed on the end of water outlet 18 is second hose nipple 24 which is operably connected to water outlet 18. The connection between the end of water outlet 18 and second hose nipple 24 can be a female/male thread combination, a mechanical joint, an adhesive joint or metal joinery such as a solder joint. Preferably, second hose nipple 24 is a ¾″ MH×½″ FIP H nipple. However, any other suitable and/or desired nipple may also be used.

Lining 28 (FIG. 8A) is applied to the inside of housing 14 and lining 26 protects the inside of housing 14 from the damaging effects of the water introduced into portable water heating system 10. Lining 28 can be produced from various materials such as plastic, metal, metal-alloys, rubber, fiberglass, epoxy, synthetic rubber compounds, latex compounds, polyurethane, fiber resin composite materials and combinations of these, however, other materials may be used.

An element that further protects the inner system components of portable water heating system 10 is anode 31. Anode 31 is disposed inside housing 14 and protects the inner system components of portable water heating system 10 from the damaging effects of the water. The anode works by readily giving up electrons and corroding away itself before the other internal components of housing 14 thereby protecting them from corrosion.

To improve safety and convenience, portable water heating system 10 further comprises an adjustable thermostatic control 38 (FIG. 6) disposed between the external electrical supply and heating element 26 (FIG. 4). Adjustable thermostatic control 38 controls the thermal output of heating element 26. Adjustable thermostatic control 38 also includes a high temperature shutoff element located in the adjustable thermostatic control. The high temperature shutoff element protects the user and portable water heating system 10 by shutting the system down when a predetermined threshold has been exceeded.

Another safety feature of portable water heating system 10 further comprises a first ground fault detecting device 40 (FIG. 5) disposed between the external electrical supply and the adjustable thermostatic control. First ground fault detecting device 40 protects a user from electrical shock when using portable water heating system 10. In an alternative embodiment of the invention, a second ground fault detecting device is also included and is disposed between the external electrical supply and the heating element.

Still yet another safety feature of portable water heating system 10 further comprises relief value 56 (FIG. 1) mounted on the outside of housing 14. Relief value 56 releases excess pressure from the inside of housing 14 thereby protecting the user and portable water heating system 10.

Water inlet 16 brings water into the inside of housing 14 via a hose or other conduit connected to first hose nipple 22. The water is then heated by heating element 26 (FIG. 4). Heating element 26 is disposed on the outside of housing 14 and has a first end 28 and second end 30. First end 28 sealingly protrudes from the outside of the housing and receives an external electrical supply from heating element 26. Second end 30 is disposed inside housing 14 and heats the water brought inside the housing by water inlet 16. Water outlet 18 is then used to dispense the heated water from inside the housing via a hose or other similar conduit connected to second hose nipple 24.

Referring now to FIG. 7, to promote the portability of portable water heating system 10, the system further comprises a set of wheels 42 mounted on the outside of portable housing 14. Wheels 42 facilitate moving the system for a user. In an alternative embodiment, rollers 42 can be utilized to facilitate moving the system for a user.

In another embodiment of the invention that promotes the portability of portable water heating system 10, the system further comprises handle 46 attached to the outside of housing 14. Handle 46 facilitates the moving of the system by a user. In one embodiment, handle 46 is a fixed structure and in another embodiment, handle 48 is flexible. In another embodiment, handle 46 or handle 48 is retractable and in another embodiment, handle 46 is folding. In still yet another embodiment, side handles 50 are disposed on the sides of housing 14 to facilitate the moving of the system by a user.

Because of the portable nature of portable water heating system 10, storage of the unit needs to be addressed. In one embodiment of the invention, the portable nature of portable water heating system 10 is further addressed by including mounting element interface 52 located on the outside of housing 14. Mounting element interface 52 serves to secure portable water heating system 10 to a mounting element when not in use.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A portable water heating system, the system comprising:
a housing with an inside and an outside;
a water inlet disposed on the outside of the housing;
a first hose nipple attached to the water inlet, the first hose nipple adapted to connect a water source to the system;
a heating element adapted to heat water inside the housing;
a lining disposed inside of the housing, the lining adapted to protect the inside of the housing from water corrosion;
a water outlet disposed on the outside of the housing; and
a second hose nipple attached to the water outlet, the second hose nipple adapted to connect a fluid conduit for heated water distribution.

2. The system of claim 1 further comprising an adjustable thermostatic control controlling the output of the heating element.

3. The system of claim 2 further comprising a first ground fault protection device disposed between an external electrical supply and the adjustable thermostatic control and a high temperature shutoff element located in the adjustable thermostatic control, the high temperature shutoff element protecting the system by shutting the system down when a predetermined threshold temperature has been exceeded.

4. The system of claim 1 further comprising a set of wheels mounted on the outside of the housing.

5. The system of claim 1 further comprising a handle attached to the outside of the housing.

6. The system of claim 5 wherein the handle is selected from the group consisting of a fixed handle, a folding handle, a retractable handle, a molded handle and combinations of these.

7. The system of claim 1 further comprising a mounting element interface located on the outside of the housing, the mounting element interface securing the system to a mounting element when not in use.

8. The system of claim 3 further comprising an insulated barrier surrounding the outside of the housing, a second ground fault protection device disposed between the external electrical supply and the heating element, and wherein no coiled water conducting tube is provided so as to remove an element prone to failure due to clogging from the system.

9. The system of claim 1 further comprising a relief value disposed on the outside of the housing, wherein the housing comprises a double walled housing and an anode disposed inside the housing, the anode protecting parts located on the inside of the housing from corrosive effects of water.

10. The system of claim 9 wherein an outer wall of the housing is made of a material different than an inner wall of the housing.

11. The system of claim 1 wherein the housing material is selected from the group of materials comprising plastic, metal, metal-alloys, rubber, fiberglass, epoxy, synthetic rubber compounds, latex compounds, polyurethane, fiber resin composite materials and combinations of these.

12. A portable water heating system, the system comprising:
a housing with an inside and an outside;
a water inlet disposed on the outside of the housing;
a first hose nipple attached to the water inlet, the first hose nipple adapted to connect a water source to the system;
a heating element adapted to heat water inside the housing;
a lining disposed inside of the housing, the lining adapted to protect the inside of the housing from water corrosion;
a water outlet disposed on the outside of the housing;
an adjustable thermostatic control controlling the output of the heating element;
a first ground fault protection device disposed between an external electrical supply and the adjustable thermostatic control;
a high temperature shutoff element located in the adjustable thermostatic control, the high temperature shutoff element protecting the system by shutting the system down when a predetermined threshold temperature has been exceeded; and
a second hose nipple attached to the water outlet, the second hose nipple adapted to connect a fluid conduit for heated water distribution.

13. The system of claim 12 further comprising a first ground fault detecting device disposed between the external electrical supply and the adjustable thermostatic control and a high temperature shutoff element located in the adjustable thermostatic control, the high temperature shutoff element protecting the system by shutting the system down when a predetermined threshold has been exceeded.

14. The system of claim 12 further comprising a set of wheels mounted on the outside of the housing.

15. The system of claim 12 further comprising a handle attached to the outside of the housing.

16. The system of claim 12 wherein the handle is selected from the group of structures of fixed, folding, retractable, molded and combinations of these.

17. A method of increasing safety when using a portable water heating system, the method comprising:
providing a portable water heating system with a heating element;
controlling the heating element operation with an adjustable thermostatic control;
providing a ground fault detecting device between the adjustable thermostatic control and the external electrical supply; and
shutting off the system with a high temperature shutoff element forming a part of the adjustable thermostatic control, when a predetermined threshold has been exceeded.
